(19) United States
(12) Patent Application Publication
(10) Pub. No.: US 2021/0269181 A1
(43) Pub. Date: Sep. 2, 2021

(54) SEALING SYSTEM FOR CONTAINERS

(71) Applicant: WEIGHTPACK S.R.L., Goito, Mantova (IT)

(72) Inventor: Vanni ZACCHE', Goito, Mantova (IT)

(21) Appl. No.: 15/777,596

(22) PCT Filed: Oct. 17, 2016
(86) PCT No.: PCT/IB2016/056218

§ 371 Date: May 18, 2018

(30) Foreign Application Priority Data
Nov. 19, 2015 (IT) 102015000074321

(51) Int. Cl. B65B 7/01; B65B 7/16; B67C 7/00; B26F 1/38

(52) U.S. Cl. CPC B65B 7/01; B26F 1/3846; B67C 7/00; B65B 7/162

(57) ABSTRACT

A sealing system is for containers, in particular of the type that envisages sealing with an aluminum cap. Forming equipment of a cap or seal of weldable sealing material is for the application on the mouth of a container. The equipment includes at least one cutting device (48) of a disc or sheet of the sealing material from a web of the sealing material. The at least one cutting device (48) is arranged along the periphery of a cutting roll (30) and the cutting roll (30) is motorized so as to move the web of sealing material by traction along an operational path.

The present invention relates to a sealing system for containers, in particular of the type which envisages sealing with an aluminum cap.

In sensitive liquid packaging systems, sealing systems of the mouths of the bottles or containers are used immediately after filling in order to guarantee integrity and absence of bacterial contamination. Filling is typically performed in sterile atmosphere.

Examples of applications of this type are milk and milk derivatives, fresh fruit juice, isotonic beverages and generally all applications characterized by extreme organoleptic sensitivity and high possibility of perturbation due to uncontrolled environmental aspects, arriving to the most delicate pharmaceutical applications.

Sealing systems of this type envisage the welding of an aluminum cap onto the mouth of the container and consist of a plurality of discontinuous steps which generate low productivity and high risk of errors and malfunctions. In particular, the plastic-coated aluminum seal is formed by cutting/plastic deformation starting from semi-finished web on reels by means of a plurality of reciprocating and linear movements.

In the known machines, the step of forming of the seal or cap is performed in an area outside the controlled atmosphere zone, and then the cap is conveyed into the controlled atmosphere zones by means of a carrying channel, generally located at a greater height so as to exploit the force of gravity to advance the seals. Sterilization means, typically of the induced energy type (UV radiations), which guarantee the sterility of both the caps and the inlet air, are arranged along the carrying channel. Finally, the caps are positioned on the transiting containers through a release head. Downstream of this equipment there is a machine for thermally welding the seal onto the mouth of the container.

The system described above has a number of limitations and inefficiencies which negatively influence production continuity of the system mainly because of the criticality of conveying the caps from the outside into the controlled atmosphere chamber, and very often require restoring operations which may even cause the alteration of the controlled atmosphere. This causes the rejection of considerable amounts of product and the need for various sanitation cycles to restore the correct environmental quality in the controlled atmosphere zone.

The problem addressed by the present invention is thus to make available a sealing system of containers which solves the problems inherent to the equipment of the prior art.

Such a problem is solved by a forming equipment of a seal or cap for the mouth of containers as outlined in the appended claims, the definitions of which form an integral part of the present description.

In particular, the invention relates to a system for making and distributing caps or seals on the mouth of a container having the following features:
being free from operative discontinuities,
the shearing, forming and depositing process of the cap or seal on the mouth of the container is performed entirely inside the controlled atmosphere chamber,
the seals or caps are entirely moved by retaining and carrying members, thus preventing steps in which they are subject to freely falling upstream of the releasing point of the cap onto the mouth of the container,
continuous sterilization of the sealing material web (typically plastic-coated aluminum) before cutting for forming seals or caps.

Further features and advantages of the present invention will be apparent from the description of some examples of embodiment, given here by way of non-limiting example with reference to the following figures:

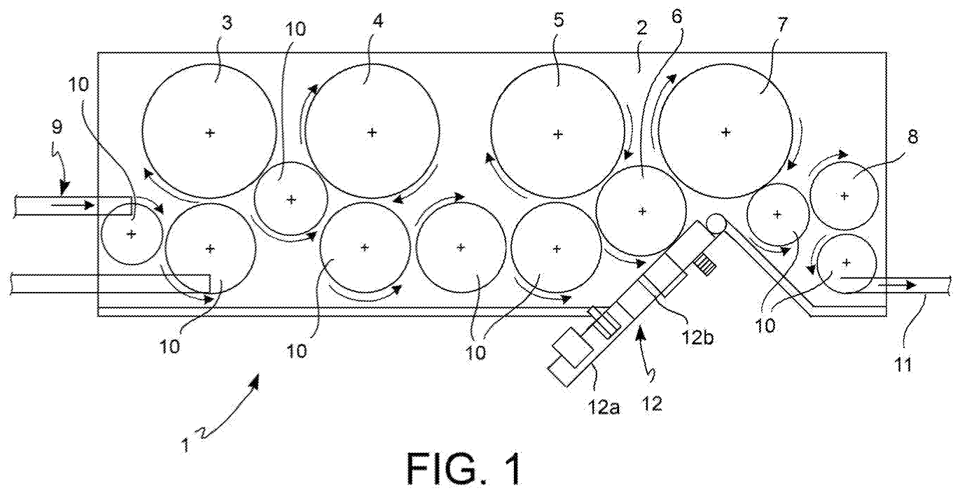

FIG. 1 is diagrammatic plan view of a container filling and sealing system which comprises the forming equipment according to the present invention;

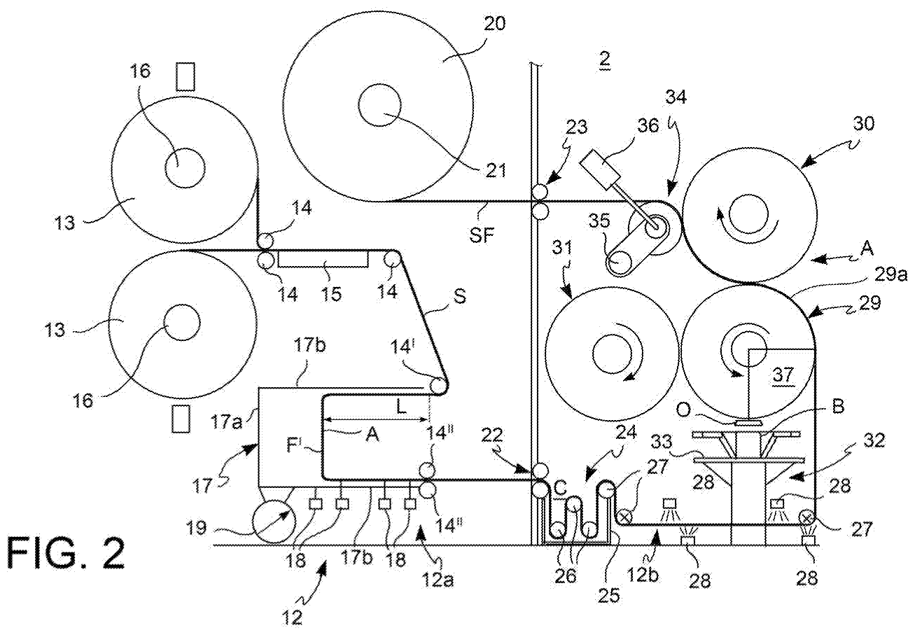

FIG. 2 is a diagrammatic view of the forming equipment according to the invention;

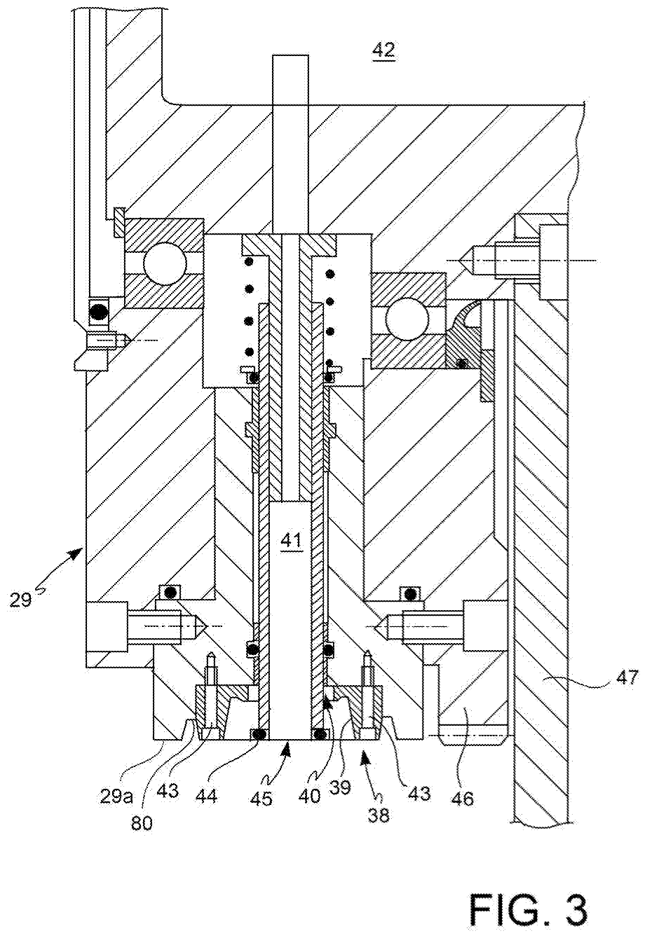

FIG. 3 is a front view (according to direction A in FIG. 2) of the positioning roll according to the invention;

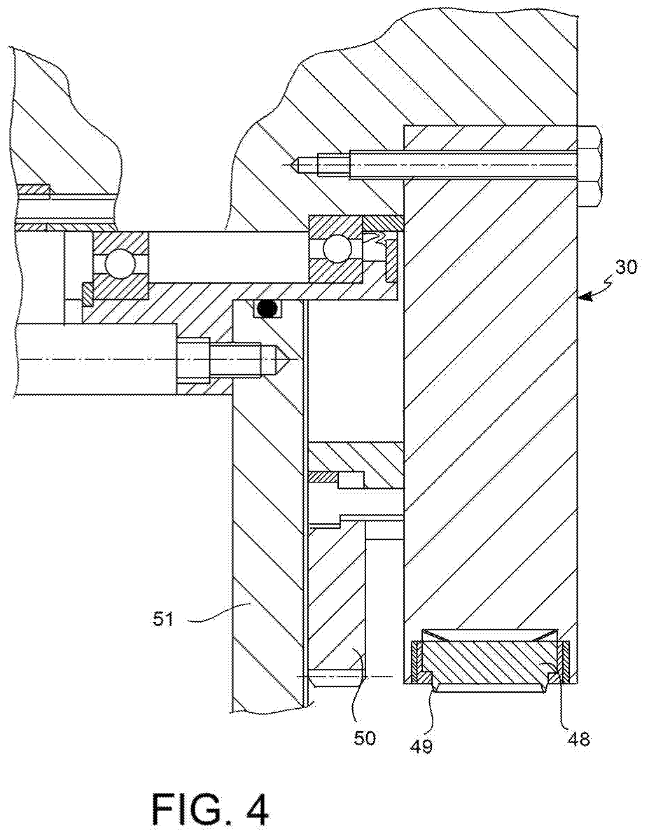

FIG. 4 is a front section view (according to direction A in FIG. 2) of a detail of the cutting roll according to the invention;

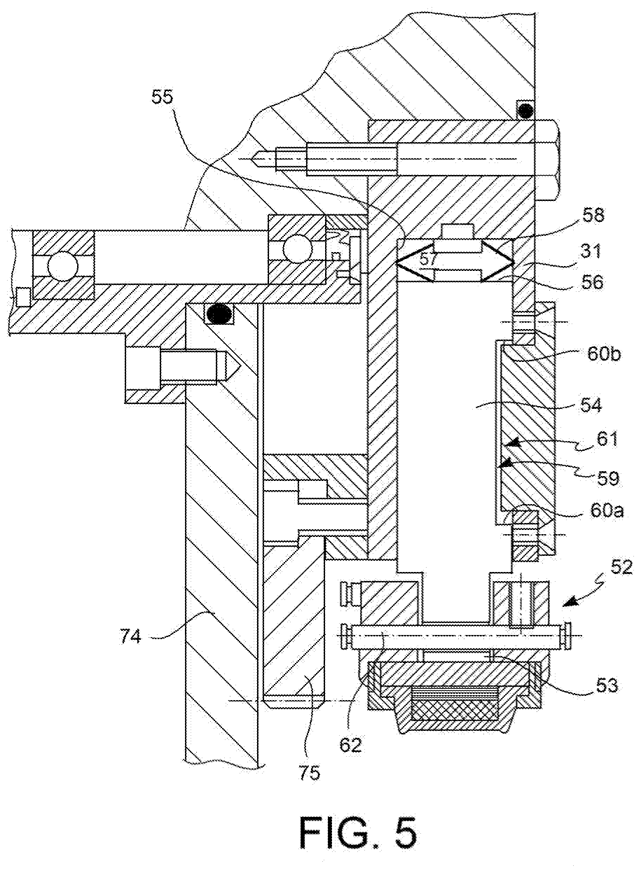

FIG. 5 is a front view (according to direction A in FIG. 2) of a detail of the forming roll according to the invention;

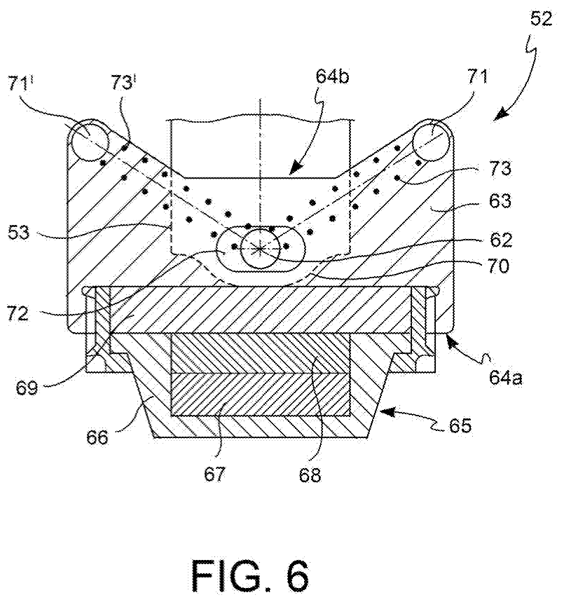

FIG. 6 is a side section view (perpendicular to direction A in FIG. 2) of the swinging punch of the forming roll in FIG. 5.

With reference to FIG. 1, the filling and sealing system of containers according to the present invention, indicated by reference numeral 1 as a whole, comprises a controlled atmosphere chamber 2, in particular a cleanroom, in which the following are arranged in sequence:
a sterilization unit 3,
a rinsing unit 4,
a filling unit 5,
a unit 6 for receiving the seal or cap,
a sealing unit 7, and
optionally, a capping unit 8.

The containers, bottles, flasks or the like enter into the controlled atmosphere chamber 2 through a first conveyor 9 and are moved between the various processing unit by means of transfer stars 10 to then be removed from the controlled atmosphere chamber 2 by a second conveyor 11.

The processing units 3, 4, 5, 6, 7, 8, the conveyors 9, 11 and the transfer stars 10 are of the conventional type and will be selected according to the type of containers and products to be treated. The layout of the filling and sealing system may also be modified to take particular production needs into account.

The filling and sealing system 1 further comprises a forming equipment 12 of a cap or seal made of a material, typically plastic-coated aluminum, which is weldable on the mouth of a container.

The forming equipment 12 comprises a service portion 12a outside a controlled atmosphere chamber 2 and an operating portion 12b within the controlled atmosphere chamber 2.

The service portion 12a comprises at least one reel 13, typically two reels 13 so to have a spare for rapidly replacing the finished reel, of sealing material S and a series of return rolls 14, 14′, 14″ for moving the web of sealing material S unwound from the reel 13.

The sealing material S is normally plastic-coated aluminum in form of web.

The web of sealing material S is moved by traction, in particular by the cutting roll, as will be described below. The reels 13 are thus provided with a brake system or a servo drive associated with the respective unwinding spindle 16 so as to prevent the uncontrolled unwinding thereof.

Preferably, a suction surface 15, the function of which is to fix the web of material S in position at the time of joining for changing the reel, is arranged downstream of the reel.

Between the reels 13 and the inlet point of the web of material S into the operating portion 12b of the equipment 12 there is a buffer chamber 17, having a bottom wall 17a and side walls 17b. Vacuum V is applied to the buffer chamber 17 by means of suitable suction means 19, such as a fan, so as to create a loop A of the web of sealing material S between a first return roll 14′ and a second pair of return rolls 14″.

The buffer chamber 17 comprises a series of detection sensors 18, typically photocells, arranged along a side wall 17b, so as to detect the length L of the loop A between respective return rolls 14′, 14″ and the bottom F′ of the loop A. The detection sensors 18 are connected to a command and control unit (not shown), which in turn is connected to the unwinding spindles 16 so as to adjust the extent of the brake or the activity of the servo drives of the spindles 16 as a function of the length L of the loop A. In this manner, both the length L of the loop A in case of possible decelerations or accelerations of the downstream operating steps and the tensioning of the web of sealing material S as determined by the value of the vacuum V in the buffer chamber 17, can be maintained constant.

The service portion 12a of the equipment 12 comprises a rewinding reel 20 operated by a motorized rewinding spindle 21, which recovers the scrap tape SF of sealing material S (see the following steps of the process).

Downstream of the buffer chamber 17, the web of sealing material S is introduced into the operating portion 12b of the equipment 12, in the controlled atmosphere chamber 2. For this purpose, the controlled atmosphere chamber 2 comprises a roll inlet port 22 comprising two opposing rolls through which the web of sealing material S passes. Similarly, the controlled atmosphere chamber 2 comprises a roll outlet port 23 through which the scrap tape SF passes before it is wound on the rewinding spindle 20. In this manner, the separation between controlled atmosphere chamber 2 and the outside of the equipment (service portion 12a) is obtained. An overpressure of air or other sterile gas present in the controlled atmosphere chamber 2 will avoid the introduction of non-sterile air into the operating portion 12b.

Once inside the operating portion 12b of the equipment 12, the web of sealing material S passes through sterilization means 24. Such sterilization means 24 preferably comprise a tank 25 containing a sterilizing liquid C, e.g. a solution of peracetic acid. Rolls 26 are arranged in the tank 25 so as to create a tortuous path for the web of sealing material S in order to prolong the permanence time thereof in contact with the sterilizing liquid.

The web of sealing material S is then conveyed, by means of appropriate return rolls 27, through rinsing or activation means 28, e.g. a series of spray nozzles dispensing sterile water or steam. Indeed, by way of example, if peracetic acid is used as sterilizer, it will suffice to rinse the web of sealing material S, while if hydrogen peroxide is used, it must be activated by means of steam.

Sterilization means of different type may be provided, e.g. a UV radiation system, in different embodiments. In such a case, the rinsing or activation means 28 may also be eliminated.

Downstream of the rinsing means 28 a positioning roll 29 is arranged on which the web of sealing material S is made to adhere.

The positioning roll 29 is tangential, in the order according to the direction of rotation of the roll, firstly with a cutting roll 30, adapted to cut a sheet of sealing material S from the web, and then with a forming roll 31, adapted to shape the cut material S into a cap or seal, e.g. in the characteristic crown shape.

The receiving unit 6, which comprises a conveyor having a plurality of plates 33, each of which holds a container B to be sealed, or alternatively a sliding surface in common to all the containers B to be sealed, is arranged underneath the positioning roll 29.

The outer surface 29a of the positioning roll 29 is connected to vacuum means so that the web of sealing material S is retained on said outer surface 29a up to the cutting roll 30. The sheet of sealing material S (which will later be shaped to provide a seal or cap O) is cut in the tangential point between positioning roll 29 and cutting roll 30, the sheet remaining adherent to the positioning roll 29 by virtue of the suction, while the scrap tape SF is drawn by the cutting roll 30, which is motorized, passing between it and a counter-pressure roll 34, and exits from the controlled atmosphere chamber 2 through the outlet roller door 23 to be rewound on the rewinding reel 20.

The counter-pressure roll 34 swings around a hinge 35 and is pneumatically operated, by means of a pneumatic cylinder 36, or in other embodiments by means of elastic systems, e.g. spring systems, so as to ensure a predetermined pressure on the cutting roll 30 and thus promote the traction of scrap tape SF.

The positioning roll 29 comprises, at the tangency point with the container B to be sealed, a sector 37 in which the vacuum is blocked, so that the cap or seal O, once the vertical is reached over the mouth of the container B, may be released so as to be positioned on it. The conveyor 32 thus moves away the container B on which the seal or cap O is positioned. The container B will then be transferred onto the hot sealing unit 7, where a press, of the thermal rotary or induction or ultrasounds welder type, welds the seal or cap O onto the mouth of the container B.

The positioning roll 29 comprises a plurality of mold elements 38 of said seal or cap O along its outer surface 29a. FIG. 3 shows a cross section (taken along direction A in FIG. 2) of one of such mold elements 38.

Each mold element 38 comprises a mold profile 39 which reproduces in negative the shape of the seal or cap O. The mold profile 39 comprises a central hole 40 in which a duct 41 is fitted. The duct 41 leads into the central portion 42 of the positioning roll 29, which, with the exclusion of the sector 37, is connected to vacuum means. In this manner, the sheet of sealing material S, which is cut at the tangency point with the cutting roller 30, may be retained by the vacuum in the correct position for the subsequent forming step.

The mold profile 39 is fixed in removable manner, e.g. by means of fixing screws 43, to the surface of the positioning roll 29, so that it can be replaced in case of wear or for adapting the equipment 12 for another type of seal.

A ring 44 made of ferromagnetic material, the function of which will be clarified in the description that follows, is positioned around the outer hole 45 of the duct 41.

A bas-relief profile 80 which corresponds to the perimeter of the sheet of sealing material S to be cut is present around the mold element 38.

The positioning roll 29 is fixed to a toothed wheel 46 hinged onto a support plate 47 of the equipment 1. The toothed wheel 46 is connected to the drive of the cutting roll 31 by means of an appropriate transmission member (not shown) for the synchronized movement of the positioning roll 29, the cutting roll 30 and the forming roll 31.

With reference to FIG. 4, the cutting roll 30 comprises a plurality of cutting devices 48 along its perimeter. Each cutting device 48 comprises a blade element 49 which reproduces the shape of the outline of the sheet of sealing material S for forming a seal or cap O. The blade element 49 is adapted to interact with a corresponding bas-relief profile 80 of the positioning roll 29 so as to cut a sheet of sealing material S from the web of sealing material S carried by the positioning roll 29.

The cutting roll 30 is fixed to a toothed wheel 50 hinged on a support plate 51 of the equipment 12 and is coupled with an actuator (not shown), preferably a torque direct drive type motor, e.g. a brushless motor, for its handling. The toothed wheel 50 is connected by means of an appropriate driving member (not shown) to the positioning roll 29 and the forming roll 31, so that the three rolls 29, 30, 31 move in a synchronized manner, and in particular a cutting device 48 is cyclically found at a respective mold element 38 during the operating step of the equipment 12.

The forming roller 31 comprises a plurality of forming devices 52 along its perimeter.

With reference to FIGS. 5 and 6, each forming device 52 is mounted in swinging manner to a first end 53 of a rod 54. The rod 54 is fitted in a seat 55 formed inside the forming roll 31, so that said first end 53 protrudes outwards, while the second end 56, opposite to the first end, faces towards a cavity 57 and pushes against a pre-calibrated spring 58, preferably a cup spring.

The rod 54 has a recessed portion 59 with a lower shoulder 60a and an upper shoulder 60b. The lower shoulder 60a and the upper shoulder 60b form stroke limiting means of the rod 54 by interacting with a corresponding internally protruding section 61 of the seat 55, having a lengthwise extension smaller than the extension of said recessed portion 59. So the rod 54 can travel a limited stroke contrasted by the pre-calibrated spring 58. In this manner, the forming device 52 can impart a predetermined forming pressure on the mold element 38 of the positioning roll 29.

A pin 62, which supports the forming device 52 in swinging manner, is transversely fitted at the first end 53 of the rod 54.

The first end 53 of the rod 54 ends with a convex profile 70 when viewed in direction perpendicular to the plane of the forming roll 31.

The forming device 52 comprises a body 63 having an outward facing support end 64a and a coupling end 64b with the rod 54.

A punch 65 is removably fixed at the support end 64a of the body 63. The punch is made of non-ferromagnetic material, e.g. a plastic material, and comprises a hollow body 66 which internally accommodates a magnet 67, preferably a permanent magnet. The magnet 67 is arranged in central position and is preferably cylindrical with an axis perpendicular to the bases of the cylinder aligned with a radius of the forming roll 31. If necessary, the magnet 67 may be held in position by a retaining plate 68 arranged between the magnet 67 and the base 69 of the punch 65.

The coupling end 64b of the body 63 of the forming device 52 has an widened V shape and has two fixed pins 71, 71′ at the two ends of the V. The body 63 centrally has a slot 72 arranged horizontally, in which the pin 62 of the rod 54 is fitted. A spring 73, 73′, preferably a coil spring, is arranged between each of the fixed pins 71, 71′, and the pin 62 of the rod 54.

The forming roll 31 is, in turn, hinged to a support 74 of the equipment 1 and comprises a toothed wheel 75. The toothed wheel 75 is coupled, by means of the previously described transmission member, to the actuator of the cutting roll 30 to move it in synch with the positioning roll 29 and the cutting roll 30. In particular, a forming device 52 will be cyclically at a respective mold element 38 during the operating step of the equipment 12.

The operation of the equipment 12 of the invention will now be described.

The web of sealing material S is unwound by one of the two reels 13 arranged outside the controlled atmosphere chamber 2 and enters into it through the door 22. The correct tensioning of the web is ensured by detecting the length L of the loop A by one of the detection sensors 18 and by respectively actuating the braking or servo drive system of the spindle 16 of the reel 13.

Once inside the controlled atmosphere chamber 2, the web of sealing material S is firstly sterilized by passing through the tank 25 of sterilizing liquid C, and then rinsed by the rinsing means 28 to be transferred onto the positioning roll 29, on which the web of material S adheres by means of vacuum.

Having reached the tangency point with the cutting roll 30, a sheet of sealing material S which will then form a seal or a cap O will be singled out by interaction of the mold element 38 with a cutting device 48. The scrap tape SF is moved away from the cutting roll 30 and is then rewound on the rewinding reel 20, while the sheet of material S is retained by the vacuum applied by the mold element 38 through the duct 41 and is then held in this position until the tangency point with the conveyor 32 is reached, on the vertical of the container B, after having passed the tangency point of the positioning roll 29 with the forming roll 31 and been formed into a seal or a cap O. When the seal or cap O is over the container B, the vacuum is interrupted and the seal or cap O is released and drops by gravity on the mouth of the container B, ready for the next step of sealing.

The seal or cap O is formed as follows.

When the sheet of sealing material S carried by a mold element 38 of the positioning roll 29 approaches the tangency point with the forming roll 31, in synch with a forming device 52, the magnet 67 of the latter interacts with the ring 44 of ferromagnetic material of the mold element 38. As mentioned, the forming device 52 swings about the pin and has a further degree of sliding freedom by virtue of the slot 72 in which the pin 62 is inserted. Thus, by virtue of such possibilities of movement and the magnetic attraction force exerted on the ring 44, the forming device 52 is oriented so as to follow, along its path for a rotation angle up to ±15° with respect to the tangency point between the positioning roll 29 and the forming roll 31, the mold element 38, coupling to it on opposite and parallel planes. In this manner, the interaction is obtained between punch 65 and mold profile 39 and thus the seal or cap O is formed. As mentioned above, the correct forming pressure is ensured by the calibration of the spring 58 on which the rod 54 insists.

As a consequence, the equipment 12 of the invention achieves the predetermined objects.

Indeed, the forming process of the seal or cap is continuous by interacting with the moveable rolls in synch during the step of cutting, of forming and of releasing onto the mouth of a container.

Furthermore, the forming process of the caps is performed in a sterile chamber and the caps are guided by rollers and retained adherent to them by the vacuum until it is released on the container.

It is a further object of the invention a method of sealing containers B with a seal or cap O, said method comprising the steps of:
a) introducing a web of sealing material S, preferably a plastic-coated aluminum web, into a controlled atmosphere chamber 2;
b) sterilizing said web of sealing material S;
c) moving said web of sealing material S on a positioning roll 29;
d) passing said web of sealing material S at a cutting roll 30 so as to single out a disc or sheet of sealing material S;
e) passing said disc or sheet of sealing material S on said positioning roll 29 at a forming roll 31 having at least one punch 65 so as to form said seal or cap O;
f) releasing said seal or cap O on the mouth of a container B,

wherein steps b) to f) are carried out continuously inside said controlled atmosphere chamber 2.

It is apparent that only some particular embodiments of the present invention have been described, to which a person skilled in the art will be able to make all the changes necessary to adapt it to particular applications, without however departing from the scope of protection of the present invention.

1. A forming equipment of a cap or seal of weldable sealing material for application on a mouth of a container, said equipment comprising at least one cutting device, a disc or sheet of sealing material from a web of said sealing material, wherein said at least one cutting device is arranged along a periphery of a cutting roll and in that said cutting roll is motorized so as to move by traction said web of sealing material along an operational path.

2. The equipment according to claim 1, wherein the web of sealing material adheres to a positioning roll tangent to said cutting roll, said positioning roll being connected to a vacuum adapted to retain the web of sealing material on the outer surface of the positioning roll up to the cutting roll.

3. The equipment according to claim 1, wherein at the tangency point between the positioning roll and cutting roll a scrap tape is formed, wherein said scrap tape is dragged by the cutting roll, passing between the cutting roll and a counter-pressure roll.

4. The equipment according to claim 3, wherein the counter-pressure roll is swinging around a hinge and is operated pneumatically, through a pneumatic cylinder, or by elastic systems, so as to ensure a predetermined pressure on the cutting roll and thus favor the traction of scrap tape.

5. The equipment according to claim 1, wherein the cutting roll comprises a plurality of cutting devices along the periphery of the cutting roll, each cutting device comprising a blade element which reproduces a shape of an outline of the sheet of sealing material for forming a seal or cap, said blade element being adapted to interact with a corresponding bas-relief profile which surrounds each mold element of the positioning roll so as to cut said sheet of sealing material from said web of sealing material.

6. The equipment according to claim 1, wherein the cutting roll is coupled with an actuator for movement.

7. The equipment according to claim 6, wherein the cutting roll comprises a toothed wheel, the toothed wheel being connected by a driving member with the positioning roll, so that the positioning roll and the cutting roll move in a synchronized manner and a cutting device cyclically is at a respective mold element during operation of the equipment.

8. The equipment according to claim 5, wherein said mold profile is removable and interchangeable.

9. A filling and sealing equipment of containers, comprising the forming equipment according to claim 1.
